(19) United States
(12) Patent Application Publication
(10) Pub. No.: US 2024/0292205 A1
(43) Pub. Date: Aug. 29, 2024

(54) FLEXIBLE REMOTE SIM PROVISIONING

(71) Applicant: GIESECKE+DEVRIENT MOBILE SECURITY GERMANY GMBH, Munchen (DE)

(72) Inventors: Nils NITSCH, Markt Schwaben (DE); Harry LI, Stockholm (SE); Tommy THORSTENSSON, Bromma (SE); Dan THORÉN, Taby (SE); Markus HAUBNER, Altomunster (DE); Andreas KITZMANN, Munchen (DE)

(21) Appl. No.: 18/571,956

(22) PCT Filed: Jun. 30, 2022
(86) PCT No.: PCT/EP2022/025300

§ 371 Date: Dec. 19, 2023

(30) Foreign Application Priority Data
Jul. 1, 2021 (DE) 10 2021 003 391.4

(51) Int. Cl. H04W 8/18; H04W 12/0431; H04W 12/42

(52) U.S. Cl. CPC H04W 8/18; H04W 12/0431; H04W 12/42

(57) ABSTRACT

A method, on a data generation server, is for preparing generating a profile image for download from a profile server to an eUICC hosted in a device, for the purpose of installing a profile corresponding to the profile image in the eUICC, the method comprising the steps: a) at a data generation server, generate, for multiple devices, multiple non-personalized profile images, each non-personalized profile image comprising at least one functionality identifier specific for the respective device, and each non-personalized profile image not comprising any individual global identifier specific of an individual eUICC, and store the generated multiple non-personalized profile images for providing to the profile server; b) at the data generation server, generate at least one profile-data image, said profile-data image comprising at least one individual global identifier of an individual eUICC, and store the generated at least one profile-data image for providing to the profile server.

### FIELD OF THE INVENTION

The present invention relates to Remote SIM Provisioning, that is provisioning of profiles for subscriber identity Modules, or briefly SIMs, from a remote server to an eUICC, such as according to the GSMA specification SGP.22 or SGP.02.

### BACKGROUND OF THE INVENTION

The GSMA specification [1] SGP.22 RSP Technical Specification Version 2.2.2 5 Jun. 2020 (or briefly SGP.22), particularly chapter 3.1 called “Remote Provisioning” describes Remote SIM Provisioning by downloading of Profiles to an embedded Universal Integrated Circuit Card, eUICC, hosted in a device. The device is understood to be a mobile device or mobile terminal, i.e. a device or terminal having the ability to communicate in a mobile network, i.e. a wireless network. According to chapter 3.1.1 “Profile Download Initiation”, upon order by an End-User at a Mobile Network Operator (Operator, MNO), a ready-made profile already stored at the profile provisioning server SM-DP+ is reserved. After that, according to chapter 3.1.2 “Common Mutual Authentication Procedure”, a mutual authentication procedure between the profile provisioning server SM-DP+ and the eUICC is performed. After that, according to chapter 3.1.3 “Profile Download and Installation”, the reserved profile is downloaded to the eUICC, via the device, and installed in the eUICC. In the SGP.22 setup, the profile provisioning server is called SM-DP+.

Devices according to SGP.22 are particularly so-called consumer devices such as Smartphones, Smartwatches and Tablet PCs with mobile network connectivity, and other com-puters with mobile network connectivity.

Document [1] SGP.22 chapter 2.4 “eUICC Architecture”, particularly FIG. 3, describes the architecture of an eUICC. Each profile is contained in an individual ISD-P, its Issuer Security Domain Profile. Each ISD-P contains one profile. The profile has the primary technological service task of authenticating the eUICC or/and its device or/and its End-User to the mobile net-work to which the profile is associated. The ISD-P or the profile can contain additional elements like applets and applications. The applets and applications can have service purposes going beyond authentication to the mobile network, for example payment services or ticketing services. Particularly, Near Field Communication, NFC, payment services can be implemented by an NFC payment applet or application in a profile or ISD-P. Currently, also the applets and applications offered for download to an ISD-P are static and ready-made. Profiles (or generally contents) to be downloaded to the eUICC on the occasion of a Remote SIM Provisioning session as described in [1] SGP.22 chapter 3.1.3 “Profile Download and Installation” are downloaded to the eUICC in form of a Bound Profile Package BPP, which is described in greater detail in [1] SGP.22 chapter 2.5.4, and in GSMA specification [3] SGP.21, RSP Architecture, Version 2.2, 1 Sep. 2017. The Bound Profile Package contains a sequence of Tag Length Value, TLV, commands for installation of, in this order (1) an ISD-P with Configuration of the ISD-P, (2) Meta Data, (3) Profile Protection Keys, (4) the payload of the actual profile in form of the Protected Profile Package, all in the eUICC.

The GSMA specification [2] SGP.02, Remote Provisioning Architecture for Embedded UICC Technical Specification Version 4.1 5 Jun. 2020 has the aim to define a technical solution for the remote provisioning and management of the Embedded UICC (eUICC) in machine-to-machine devices, also referred to as M2M devices. Also, according to [2] SGP.02, download and installation of a profile from a profile server comprises steps of ISD-P creation, key estab-lishment, and download and installation of the profile.

The profile data of a profile comprise several individual data unique for every profile, for example the International Mobile Subscriber Identity IMSI, the authentication key Ki, and the profile number International Circuit Card IDentifier, ICCID.

Other data are specific for a type of eUICC or device, for example the eUICC-ID or chip-hardware-number Equipment IDentifier, EID, (hardware identifier as identified in [2] SGP.02), or parts of EID such as a country indicator, or the International Mobile Equipment Identity IMEI (mobile equipment=device=mobile terminal), or parts of the IMEI such as the Type Allocation Code TAC indicating a type of device.

Currently, eUICCs and devices are partly standardized and universal, and partly proprie-tary and individual. Particularly, different eUICCs and different devices have different capabilities. For this reason, ready-made profiles, applets and applications are generally not fully com-patible with a target eUICC or/and device—i.e. the eUICC or/and device for which the profile, applet, application is destined—from the beginning. Instead, adaptations to the ready-made profiles, applets and applications are required, once the eUICC type and device type or/and the individual target eUICC and individual target device are known. Currently, such adaptations are often done subsequently to the download, by commands sent to the eUICC after download and installation of the profile or applet or application. The adaptions thus cause additional traffic on the mobile network, additional provisioning time, and possibly additional monetary costs.

Documents [4] EP 2 910 039 B1 and [5] EP 2 802 162 A1 from the prior art disclose each a solution seeking to reduce the download traffic from a profile server to a eUICC by providing a profile template in a device or eUICC, so only a partial profile has to be downloaded from the profile server when a new profile is desired.

Document [6] DE102015001815A1 from the prior art proposes to generate local copies of profiles in a eUICC and further use the copies as templates for new profiles, also reducing the download traffic from the profile server required for a new profile.

The above cited documents from the prior art require a profile or template to be present on the eUICC already, so as to enable download and implementation of a new profile with reduced mobile network traffic between the profile server and the set of devices and eUICC.

Document [7] WO2019120609A1 from the prior art discloses a method for adaptive generation of a profile package, for download to an eUICC and installation of a profile in the eUICC. At a data preparation server, individual profile data such as IMSI or Ki are provided. At a profile transfer server, multiple profile descriptions relating to different configurations of an eUICC and/or of a target device hosting the eUICC are provided. When the profile transfer server receives a profile download request with configuration information of a target eUICC and/or target device, the profile transfer server retrieves from its own inventory a profile description matching with the received configuration information, and from the data generation server the profile data, and generates from the profile description and the profile data the profile package for download to the eUICC. In the solution proposed in WO2019120609A1, the entire profile generation and profile package generation process is done on the fly once the configuration information on target eUICC and/or target device is available. This can take a considerable amount of time.

The document [8] EP3629611A1 from the prior art discloses a method for downloading subscriptions of a mobile radiotelephone operator in security elements, with an update mecha-nism to sequentially load, over time, updated versions of the same profile to the security element, whenever updates to the profile are available. Said subscriptions each comprise an electrical profile of said operator and personalization data specific to each security element. On the one hand, a successive generation over time of different versions of electrical profiles of said operator is performed, said different versions of the electrical profiles comprising no personalization data. On the other hand, a generation of personalization data specific to each security element is performed. At a subscription download server, and for each download of a subscription in one of said security elements, the latest version of the available electrical profile and one of said cus-tomization data are associated, so as to generate an up-to-date subscription and to download subscription to said security element.

Whereas the solution of [8] EP3629611A1 addresses temporal variations of a profile which is already present in the security element (eUICC), herein assuming a preset combination of a security element and a radiotelephone, [8] EP3629611A1 is silent about issues concerning the generation of a first profile, before the type and individuals of the target security element and target radiotelephone are known for which the profile is to be generated.

Document [9] US20160021529A1 from the prior art discloses a method of updating a profile management server by a server for creating a profile for an embedded universal integrated circuit card (eUICC), when it is detected, that information stored in a secured area of a profile stored in the eUICC is modified.

Document [10] US20170077975A1 from the prior art discloses an eUICC management method, including: acquiring, by the eUICC, capability information of a terminal in which the eUICC is embedded; and sending, by the eUICC, the capability information of the terminal to an SM platform, so that the SM platform manages a profile on the eUICC or generates a profile or manages the eUICC according to the capability information of the terminal.

### Objective of the Invention

It is an object of the present invention to provide a flexible, adaptable and at the same time reliable profile generation and download method for generating and downloading a profile to an eUICC hosted in a device. Advantageously, by the presented solution, the overall amount or/and volume of required communications between the profile server and the eUICC upon profile download and installation shall be reduced so as to reduce time and/or costs and/or risk of failure due to communication interrupts. Also, the amount of required profile adaptation should be reduced or eliminated.

Also, it would be desirous to be able to decide only late, on the provisioning stage, exactly what the device or/and eUICC requires depending on the device/eUICC capabilities and adapt the profile in such a way to build a perfect or at least widely fit package for the device/eUICC combination.

### SUMMARY OF THE INVENTION

In greater detail, the object of the invention is achieved by an embedded system with the following features, according to claim 1. Embodiments of the invention are presented in dependent claims.

The method presented is designed, on a data generation server, for preparing generating a profile image for download from a profile server to an eUICC hosted in a device, for the purpose of installing a profile corresponding to the profile image in the eUICC. The method comprises the steps:
a) at a data generation server, generate, for multiple devices, multiple non-personalized profile images, each non-personalized profile image comprising at least one functionality identifier specific for the respective device, and each non-personalized profile image not comprising any individual global identifier specific of an individual eUICC, and store the generated multiple non-personalized profile images for providing to the profile server;
b) at the data generation server, generate at least one profile-data image, said profile-data image comprising at least one individual global identifier of an individual eUICC, and store the generated at least one profile-data image for providing to the profile server.

The method thus produces non-personalized profile image and profile-data image that can be combined in a matrix-like combination method, so as to generate a personalized profile image for download to eUICCs. An instruction for such a combination, to generate a personalized profile image, can be shifted to a late stage, for example to a stage when all or at least most or all or most of the essential features and capabilities of a target device and/or target eUICC are known. The trigger for such a combination, so as to combine a personalized profile image, can be a profile download request already including all or most features and/or capabilities of the target device and/or eUICC, or at least the most essential ones. Profile adaptations after download of the profile to the eUICC can be reduced or even eliminated.

Thus, the present invention provides for a provisioning method allowing to build a well fit profile, to thereby reduce or eliminate profile adaption after profile download, and thus reduce overall profile download and installation time and possibly cost. In addition, since less after-wards adaptation of profiles is required, the risk of failures is reduced.

Preferably, the multiple non-personalized profile images and the generated at least one profile-data image are provided to the profile server.

A data generation server is implemented to perform a profile preparing generating method as described above, and comprises:
a) means implemented to generate, for multiple devices, multiple non-personalized profile images, each non-personalized profile image comprising at least one functionality identifier specific for the respective device, and each non-personalized profile image not comprising any individual global identifier specific of an individual eUICC, and store the generated multiple non-personalized profile images for providing to the profile server;
b) means implemented to generate at least one profile-data image, said profile-data image (PD) comprising at least one individual global identifier of an individual eUICC, and store the generated at least one profile-data image for providing to the profile server.

A method, on a profile server, for generating a profile image for download from the profile server to an eUICC hosted in a device, for the purpose of installing a profile corresponding to the profile image in the eUICC, comprises the steps:
a-2) at the profile server, receive from a data generation server, for multiple devices, multiple non-personalized profile images, each non-personalized profile image comprising at least one functionality identifier specific for the respective device, and each non-personalized profile image not comprising any individual global identifier specific of an individual eUTCC or lacking at least one such individual global identifier, and store the received multiple non-personalized profile images on the profile server;
b-2) at the profile server, receive from the data generation server, at least one profile-data image, said profile-data image comprising at least one individual global identifier of an individual eUICC, and store the received at least one profile-data image on the profile server;
c) at the profile server, receive—from the device or from the eUICC or from a different server or from an MNO server or from a different device or from a different eUICC—a request to download a profile to the eUICC, the request including at least one functionality requirement indicator and at least one global identifier;
d) at the profile server, select a non-personalized profile image having a functionality identifier matching with the received functionality requirement indicator;
e) at the profile server, select a profile-data image matching with the received global identifier;
f) at the profile server, combine the selected non-personalized profile image and the selected profile-data image to generate the profile image for download to the eUICC.

The method can be supplemented with the further additional steps: f) download the generated profile image to the eUICC, and, from the downloaded profile image, install the profile in the eUICC.

The method may further comprise the step: from the profile image, prepare a profile package, and provide for download, and/or download, the profile image to the eUICC in form of the profile package.

The profile package may comprise meta data, wherein the functionality indicator is contained, or also contained, in the meta data.

A profile server according to the present invention comprises means for executing a method as described above, the profile server particularly comprising:
a-2) means implemented to receive from a data generation server, for multiple devices, multiple non-personalized profile images, each non-personalized profile image comprising at least one functionality identifier specific for the respective device, and each non-personalized profile image not comprising any individual global identifier specific of an individual eUICC or lacking at least one such individual global identifier, and store the received multiple non-personalized profile images (PI) on the profile server;
b-2) means implemented to receive from the data generation server, at least one profile-data image, said profile-data image comprising at least one individual global identifier of an individual eUICC, and store the received at least one profile-data image on the profile server;
c) means implemented to receive—from the device or from the eUICC or from a different server or from an MNO server or from a different device or from a different eUICC—a request to download a profile to the eUICC, the request including at least one functionality requirement indicator and at least one global identifier;
d) means implemented to select a non-personalized profile image having a functionality identifier matching with the received functionality requirement indicator;
e) means implemented to select a profile-data image matching with the received global identifier;
f) means implemented to combine the selected non-personalized profile image and the selected profile-data image to generate the profile image for download to the eUICC.

A system comprising a data generation server and a profile server. The data generation server and a profile server can be separate server, e.g. a SM-DP and a SM-SR. The data generation server and a profile server can alternatively be partial server of the same server, e.g. both be partial servers of a SM-DP+ server.

The at least one same global identifier can for example be either one or several of, or a part thereof:
international mobile subscriber identity IMSI;
authentication key Ki;
profile number ICCID.

The at least one different functionality identifier can for example be either one or several of, or a part thereof:
chip hardware identifier EID of the eUICC;
international mobile equipment identifier IMEI of the device;
type allocation code TAC of the device;
identifier of network technology being either one of the group including following network technologies: 2G technology, 3G technology, 4G technology, 5G technology, GSM, UMTS, CMDA, LTE;
a device capability indicator according to GSMA SGP.22;
a UICC capability indicator according to GSMA SGP.22.

The following list is the device capabilities defined by GSMA within SGP.22. The functionality identifier can be or comprise any one or several of the device capability identifiers listed in the following.
DeviceCapabilities::=SEQUENCE:
gsmSupportedRelease VersionType OPTIONAL,
utranSupportedRelease VersionType OPTIONAL,
cdma2000onexSupportedRelease VersionType OPTIONAL,
cdma2000hrpdSupportedRelease VersionType OPTIONAL,
cdma2000ehrpdSupportedRelease VersionType OPTIONAL,
eutranEpcSupportedRelease VersionType OPTIONAL,
contactlessSupportedRelease VersionType OPTIONAL,
rspCrlSupportedVersion VersionType OPTIONAL,
nrEpcSupportedRelease VersionType OPTIONAL,
nr5gcSupportedRelease VersionType OPTIONAL,
eutran5gcSupportedRelease VersionType OPTIONAL.

The functionality identifier can be or comprise any one or several of the UICC capabilities defined within the SGP.22 specification under section Annex H ASN.1 Definitions (Normative)—Definition of UICCCapability.

The data generation server and the profile server are, according to some embodiments:
either a SGP.02 SM-DP server and SGP.02 SM-SR server or a similar server infrastructure;
or a SGP.22 SM-DP+ or a similar server infrastructure.

In the above-described invention, the functionality requirement indicator and the global identifier are used to decide which profile image to generate and/or to download. In addition, a profile server configuration of the profile server from which the profile image is downloaded to the eUICC also takes influence on profile generation and/or on selection of a profile image for download. With the profile server configuration, control can be executed on the choice of which profile image is to be downloaded. What is downloaded can be different depending on how profile server indicators are configured. The configurations to control the indicators of the profile server configuration are controllable on the profile type level. It is also possible to via API/UI change the configuration of the indicators. Therefore, after such a change of indicators, profile image versions can be generated and downloaded, the generation and download of which wasn't possible before the change.

### BRIEF DESCRIPTION OF THE DRAWINGS

Embodiments of the invention will be described with reference to the accompanying drawings, throughout which like parts are referred to by like references, wherein represents:

FIG. 1 a data generation server and a profile server processing non-personalized profile images and profile data images, according to an embodiment of the invention;

FIG. 2 different form factors or eUICCs.

### DETAILED DESCRIPTION OF THE INVENTION

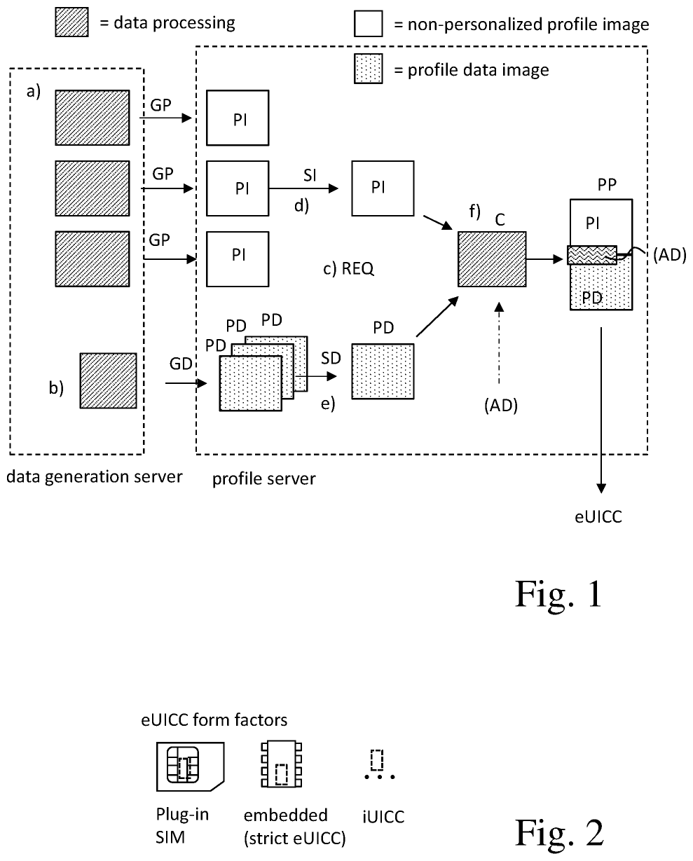

FIG. 1 shows a data generation server and a profile server processing non-personalized profile images PI and profile data images PD, according to an embodiment of the invention.

The data generation server and the profile server can for example both be part of a SM-DP+ server according to SGP.22, or similar servers according to SGP.02.

On the data generation server, several non-personalized profile images PI are generated and provided—GP—to the profile server. Also on the data generation server, several profile data images PD are generated and provided—GD—to the profile server.

Step c): at the profile server, there is received—from the device or from the eUICC or from a different server or from an MNO server or from a different device or from a different eUICC—a request to download a profile to the eUICC, the request including at least one functionality requirement indicator and at least one global identifier.

Step d): At the profile server, there is selected—SI—a non-personalized profile image PI having a functionality identifier matching with the received functionality requirement indicator.

Step e): at the profile server, there is selected—SD—a profile-data image PD matching with the received global identifier.

Step f): at the profile server, the selected non-personalized profile image PI and the selected profile-data PD image are combined C to generate the profile image PP for download to the eUICC.

In a further step—AD, adaptations to the generated profile image PP can be performed, after the selected non-personalized profile image PI and the selected profile-data PD image are combined C to generate the profile image PP.

FIG. 2 shows different form factors of eUICCs, namely, from left to right, a plug-in SIM card, an embedded UICC or eUICC in a stricter sense, and an integrated UICC or iUICC integrated into a chipset of a mobile device.

The present invention is generally not dependent on the form factor of the eUICC and is applicable to eUICCs having any of the eUICC form factors shown in FIG. 2, or still a different form factor.

The mobile device hosting the eUICC can have different form factors as well, for example smartphone, smartwatch, tablet-PC, automotive M2M device.

1.-12. (canceled)

13. A method, on a data generation server, for preparing generating a profile image for download from a profile server to an eUICC hosted in a device, for the purpose of in-stalling a profile corresponding to the profile image in the eUICC, the method comprising the steps:
a) at a data generation server, generate, for multiple devices, multiple non-personalized profile images, each non-personalized profile image comprising at least one functionality identifier specific for the respective device, and each non-personalized profile image not comprising any individual global identifier specific of an individual eUICC, and store the generated multiple non-personalized profile images for providing to the profile server;
b) at the data generation server, generate at least one profile-data image, said profile-data image comprising at least one individual global identifier of an individual eUICC, and store the generated at least one profile-data image for providing to the profile server.

14. The method of claim 13, further comprising:
a-1) providing the multiple non-personalized profile images to the profile server; and
b-1) providing the generated at least one profile-data image to the profile server.

15. A data generation server implemented to perform a profile preparing generating method according to claim 13, the data generation server comprising:
a) means implemented to generate, for multiple devices, multiple non-personalized profile images, each non-personalized profile image comprising at least one functionality identifier specific for the respective device, and each non-personalized profile image not comprising any individual global identifier specific of an individual eUICC, and store the generated multiple non-personalized profile images for providing to the profile server;
b) means implemented to generate at least one profile-data image, said profile-data image comprising at least one individual global identifier of an individual eUICC, and store the generated at least one profile-data image for providing to the profile server.

16. A method, on a profile server, for generating a profile image for download from the profile server to an eUICC hosted in a device, for the purpose of installing a profile corresponding to the profile image in the eUICC, the method comprising the steps:
a-2) at the profile server, receive from a data generation server, for multiple devices, multiple non-personalized profile images, each non-personalized profile image comprising at least one functionality identifier specific for the respective device, and each non-personalized profile image not comprising any individual global identifier specific of an individual eUICC or lacking at least one such individual global identifier, and store the received multiple non-personalized profile images on the profile server;
b-2) at the profile server, receive from the data generation server, at least one profile-data image, said profile-data image comprising at least one individual global identifier of an individual eUICC, and store the received at least one profile-data image on the profile server;
c) at the profile server, receive—from the device or from the eUICC or from a different server or from an MNO server or from a different device or from a different eUICC—a request to download a profile to the eUICC, the request including at least one functionality requirement indicator and at least one global identifier;
d) at the profile server, select a non-personalized profile image having a functionality identifier matching with the received functionality requirement indicator;
e) at the profile server, select a profile-data image matching with the received global identifier;
f) at the profile server, combine the selected non-personalized profile image and the selected profile-data image to generate the profile image for download to the eUICC.

17. The method according to claim 16, comprising the further step: f) download the generated profile image to the eUICC, and, from the downloaded profile image, install the profile in the eUICC.

18. The method according to claim 16, further comprising the step: from the profile image, prepare a profile package, and provide for download, and/or download, the profile image to the eUICC in form of the profile package.

19. The method according to claim 18, wherein the profile package comprises meta data, and
wherein the functionality indicator is contained, or also contained, in the meta data.

20. A profile server implementing means for executing a method according to claim 16, the profile server particularly comprising:
a-2) means implemented to receive from a data generation server, for multiple devices, multiple non-personalized profile images, each non-personalized profile image comprising at least one functionality identifier specific for the respective device, and each non-personalized profile image not comprising any individual global identifier specific of an individual eUICC or lacking at least one such individual global identifier, and store the received multiple non-personalized profile images on the profile server;
b-2) means implemented to receive from the data generation server, at least one profile-data image, said profile-data image comprising at least one individual global identifier of an individual eUICC, and store the received at least one profile-data image on the profile server;
c) means implemented to receive—from the device or from the eUICC or from a different server or from an MNO server or from a different device or from a different eUICC—a request to download a profile to the eUICC, the request including at least one functionality requirement indicator and at least one global identifier;
d) means implemented to select a non-personalized profile image having a functionality identifier matching with the received functionality requirement indicator;
e) means implemented to select a profile-data image matching with the received global identifier;
f) means implemented to combine the selected non-personalized profile image and the selected profile-data image to generate the profile image for download to the eUICC.

21. A system comprising a data generation server method, on a profile server, for generating a profile image for download from the profile server to an eUICC hosted in a device, for the purpose of installing a profile corresponding to the profile image in the eUICC, the method comprising the steps:
a-2) at the profile server, receive from a data generation server, for multiple devices, multiple non-personalized profile images, each non-personalized profile image comprising at least one functionality identifier specific for the respective device, and each non-personalized profile image not comprising any individual global identifier specific of an individual eUICC or lacking at least one such individual global identifier, and store the received multiple non-personalized profile images on the profile server;
b-2) at the profile server, receive from the data generation server, at least one profile-data image, said profile-data image comprising at least one individual global identifier of an individual eUICC, and store the received at least one profile-data image on the profile server;
c) at the profile server, receive—from the device or from the eUICC or from a different server or from an MNO server or from a different device or from a different eUICC—a request to download a profile to the eUICC, the request including at least one functionality requirement indicator and at least one global identifier;
d) at the profile server, select a non-personalized profile image having a functionality identifier matching with the received functionality requirement indicator;
e) at the profile server, select a profile-data image matching with the received global identifier;
f) at the profile server, combine the selected non-personalized profile image and the selected profile-data image to generate the profile image for download to the eUICC;
and a profile server according to claim 20.

22. The method or data generation server or profile server according to claim 13, wherein the at least one same global identifier is either one or several of, or a part thereof:
international mobile subscriber identity TMST;
authentication key Ki;
profile number ICCID.

23. The method or data generation server or profile server according to claim 13, wherein the at least one different functionality identifier is either one or several of, or a part thereof:
chip hardware identifier EID of the eUICC;
international mobile equipment identifier IMEI of the device;
type allocation code TAC of the device;
identifier of network technology being either one of the group including following net-work technologies: 2G technology, 3G technology, 4G technology, 5G technology, GSM, UMTS, CMDA, LTE;
a device capability indicator according to GSMA SGP.22;
a UICC capability indicator according to GSMA SGP.22.

24. The method or data generation server or profile server according to claim 13, wherein the data generation server and the profile server are:
either a SGP.02 SM-DP server and SGP.02 SM-SR server or a similar server infrastructure; or
a SGP.22 SM-DP+ or a similar server infrastructure.
